(19) United States
(12) Patent Application Publication
(10) Pub. No.: US 2009/0260974 A1
(43) Pub. Date: Oct. 22, 2009

(54) Apparatus and method for manufacturing halogen gas and halogen gas recovery and circulatory system

(76) Inventors: Yoichiro Numasawa, Tokyo (JP); Tsutomu Tsukada, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/457,672

(22) Filed: Jun. 18, 2009

Related U.S. Application Data
(62) Division of application No. 11/639,155, filed on Dec. 15, 2006.
Application No. 11/639,155 is a continuation of application No. 10/642,619, filed on Aug. 19, 2003, now abandoned.

(30) Foreign Application Priority Data
Aug. 20, 2002 (JP) 2002-239436

(51) Int. Cl. C01B 7/00

(52) U.S. Cl. 204/164

(57) ABSTRACT

The present invention provides a method and apparatus for manufacturing halogen gas using a plasma chemical reaction, with the features of having simplicity, practicality, and maintaining safety in handling source materials and of being able to manufacture halogen gas in the same facility where halogen gas is used, and also provides a halogen gas circulatory and recovery system capable of circulating and using halogen gas efficiently. After the gas expressed in the chemical formula AᵢXⱼ (A represents metallic element or semiconductor element, X represents halogen element, and i and j represent integers) is introduced into a reaction container in vacuum, plasmas are generated in the reaction container to produce a plasma chemical reaction. Fine particles produced by the plasma chemical reaction and containing an element other than halogen element as the major constituent are removed from the reaction container so as to generate halogen gas in the reaction container.

### BACKGROUND OF THE INVENTION

1. Field of the Invention

The present invention relates to a method and apparatus for readily manufacturing halogen gas by making use of a plasma chemical reaction. The present invention also relates to a halogen gas recovery and circulatory system which efficiently circulates and uses halogen gas by making use of the before mentioned method and apparatus for manufacturing halogen gas.

2. Description of the Related Art

The most common approach to industrially manufacturing fluorine gas is to electrolyze KF.2HF molten salt by heating to the range of from 70 to 90° C. As an example, Japanese Patent Application Laid-open (JP-A) No. 2002-161387 discloses a method for manufacturing fluorine gas in the following manner: about 1.5 tons of KF.2HF molten salt is put into a bath measuring about 2 m×0.8 m×0.8 m; the salt is electrolyzed at a current value of 500 to 7000 A and at an electrolytic temperature of 70 to 90° C. so as to generate fluorine gas; and hydrogen fluoride corresponding in amount to the generated fluorine and hydrogen gases is supplied if necessary, thereby continuing to manufacture fluorine gas.

Another approach to manufacturing fluorine gas is to heat a fluorine-containing solid (K₃NiF₇, for example).

In the before described conventional approaches, the method for electrolyzing an electrolytic solution such as KF.2HF molten salt has the problem that extreme caution should be exercised in handing the source material of hydrogen fluoride, which is highly corrosive and hazardous to humans.

In addition, the method for electrolyzing an electrolytic solution such as KF.2HF molten salt is effective in mass production, but is not preferable to manufacture the fluorine gas near the facility where fluorine gas is used, since it is easy to use.

On the other hand, the method for heating the fluorine-containing solid is excellent in terms of simplicity in use, but is not appropriate in terms of practicality including the cost of manufacturing because the total amount of fluorine gas obtained is small.

The present invention has an object of providing a method and apparatus for manufacturing halogen gas by making use of a plasma chemical reaction, with the features of being simple in use and practical, keeping hazardous source material in a safe condition and manufacturing halogen gas in the same facility where halogen gas is used. The present invention has another object of providing a halogen gas recovery and circulatory system which can recover exhaust gas from a vacuum chamber, the exhaust gas being produced during the process in the chamber that accommodates a substrate to be processed for semiconductor manufacturing equipment or the like; which can separate halogen gas from the exhaust gas to refine it; and which can efficiently circulate and use the halogen gas.

### SUMMARY OF THE INVENTION

The inventors of the present invention, who had been in pursuit of the achievement of the objects, found out that the objects can be achieved by generating the plasmas of halogen element-containing gas in a reaction container and then removing fine particles produced by the plasma chemical reaction and containing an element other than halogen element as the major constituent from the reaction container. Thus, they have completed the present invention.

To be more specific, one aspect of the present invention provides a method for manufacturing halogen gas comprising the steps of: introducing gas expressed in the chemical formula AᵢXⱼ (A represents metallic element or semiconductor element, X represents halogen element, and i and j represent integers) into a reaction container in vacuum; generating plasmas in the reaction container so as to produce a plasma chemical reaction; removing fine particles produced by the plasma chemical reaction and containing an element other than halogen element as the major constituent from the reaction container so as to generate halogen gas in the reaction container.

Alternatively, another aspect of the present invention provides a method for manufacturing halogen gas comprising the steps of: introducing gas expressed in the chemical formula AᵢXⱼ (A represents metallic element or semiconductor element, X represents halogen element, and i and j represent integers) into a reaction container in vacuum; generating plasmas in the reaction container so as to produce a plasma chemical reaction; collecting fine particles produced by the plasma chemical reaction and containing an element other than halogen element as the major constituent to a fine particle collecting part installed in the reaction container or in a fine particle collection container connecting with the reaction container so as to proceed the plasma chemical reaction, thereby generating halogen gas in the reaction container.

In the before described aspects, the method introducing the gas into the reaction container in vacuum is not restricted to use any container such as cylinder. For example, it is possible to combine the reaction container with another processing equipment which uses halogen gas; to recover the exhaust gas produced during the process in the said processing equipment from it; and in turn to introduce separated and refined gas expressed by the chemical formula AᵢXⱼ into the reaction container in vacuum.

After the gas expressed by the chemical formula AᵢXⱼ is introduced into the reaction container in vacuum, plasmas are generated in the reaction container. This produces a plasma chemical reaction (for example, AX→fine particles composed of element A+X or X₂ (gas)) which achieves a state of equilibrium where there is a balance between the reaction in the rightward direction and the reaction in the leftward direction. However, removing the fine particles composed of element A from the reaction container makes the reaction proceed in the rightward direction, thereby promoting the generation of X or X₂ gas.

The fine particles composed of element A produced by the plasma chemical reaction become negatively charged. Therefore, when an electrode plate applied with a positive potential against the ground is installed as a fine particle collecting part either in the reaction container or in a fine particle collection container connecting with the reaction container, the fine particles composed of element A produced by the plasma chemical reaction are captured or collected by the electrode plate and removed from the reaction container. A fine particle collecting technique making use of this phenomenon was reported by Sato et al. (Noriyoshi Sato et al.: No. 17, “Plasma Processing Workshop” proceedings pp. 617-620, January 2000).

Therefore, as the plasma chemical reaction proceeds, the fine particles composed of element A are collected to the electrode plate in the fine particle collecting part, thereby making X or X₂ gas increase with time in the reaction container.

Upon completing the plasma chemical reaction, the application of high frequency is suspended to terminate the generation of plasmas. Whether the plasma chemical reaction is complete or not can be checked by a light-emitting monitor incorporated for detection.

Since X or X₂ gas generated by the plasma chemical reaction is left inside the reaction container, halogen gas can be obtained by removing the gas in the reaction container with a pump or the like.

In the present invention, AᵢXⱼ as a source gas can be replaced by oxygen element-containing AₖXₗOₘ (A represents metallic element or semiconductor element; X represents halogen element; represents oxygen; and k, l, and m represent integers) or nitrogen element-containing AᵣXₛNₜ (A represents metallic element or semiconductor element; X represents halogen element; N represents nitrogen; and r, s, and t represent integers).

In the present invention, the gas to be introduced into the reaction container in vacuum preferably includes oxygen gas or nitrogen gas in addition to AᵢXⱼ, AₖXₗOₘ, or AᵣXₛNₜ in order to stimulate the decomposition of the introduced gas and also to speed up the reaction for generating the fine particles. The plasma chemical reaction in this case proceeds as follows: AᵢXⱼ (AₖX₁Oₘ, AᵣXₛNₜ)+O₂ or N₂→a mixture of fine particles composed of element A and fine particles composed of element A and either oxygen element or nitrogen element+X or X₂ (gas). The mixture of the fine particles composed of element A and the fine particles composed of element A and either oxygen element or nitrogen element generated by the plasma chemical reaction is collected to the electrode plate in the fine particle-collecting part provided in the reaction container or in the fine particle collection container connecting with the reaction container, and removed from the reaction container. As a result, the plasma chemical reaction proceeds with an increase in X or X₂ gas with time in the reaction container.

In the present invention, an electrode plate applied with a positive potential against the ground can be adopted as the fine particle collecting part. Also, in the present invention, it is preferable that, in the chemical formula AᵢXⱼ, A represents silicon (Si), X represents fluorine (F), and i<j. For example, SiF₄, Si₂F₆, Si₃F₈, and Si₂F₅ (unstable) can be used as the gas expressed in the chemical formula AᵢXⱼ. And, it is preferable that in AₖXₗOₘ and AᵣXₛNₜ, A represents silicon (Si), X represents fluorine (F), and k<1 and r<s, respectively.

The apparatus for manufacturing halogen gas according to the present invention comprises: a reaction container; a gas introduction part which introduces gas into the reaction container; a plasma exciting electric field application part which generates plasmas in the reaction container; and a fine particle collecting part which is installed in the reaction container or in a fine particle collection container connecting with the reaction container. In this case, an electrode plate applied with a positive potential against the ground can be used as the fine particle collecting part. This apparatus for manufacturing halogen gas according to the present invention can be used in any of the above-mentioned methods for manufacturing halogen gas according to the present invention.

The halogen gas recovery and circulatory system of the present invention comprises a vacuum chamber, a gas separation and refinement mechanism and the above mentioned apparatus for manufacturing halogen gas of the present invention. The said vacuum chamber accommodates a substrate to be processed. And the said gas separation and refinement mechanism is connected to the said vacuum chamber and recovers exhaust gas produced during the process in the said vacuum chamber, and separates the gas containing halogen element and metallic element or semiconductor element from the exhaust gas so as to refine it. The gas separation and refinement mechanism and the gas introduction part of the above-mentioned apparatus for manufacturing halogen gas of the present invention are connected by a pipe. The separated and refined gas containing halogen element and metallic element or semiconductor element is conveyed from the gas separation and refinement mechanism to the said gas introduction part of the apparatus for manufacturing halogen gas through the said pipe. And the apparatus for manufacturing halogen gas and the vacuum chamber are connected through the halogen gas drawing part, which connected in one part with the said apparatus for manufacturing halogen gas and connected in the other part with the halogen gas introduction part of the vacuum chamber.

An example for recovering and circulating halogen gas by using the halogen gas recovery and circulatory system of the present invention is carried out as follows: a halogen gas drawing part is connected with the apparatus for manufacturing halogen gas so as to draw halogen gas from the said apparatus; the drawn halogen gas is conveyed into a vacuum chamber of semiconductor manufacturing equipment or the like, which accommodates a substrate to be processed so as to use the halogen gas for etching or other processes applied to the substrate to be processed in the said vacuum chamber; the exhaust gas produced in the process in the said vacuum chamber is recovered and then the gas containing halogen element and metallic element or semiconductor element is separated from the exhaust gas and refined; and the separated and refined gas containing halogen element and metallic element or semiconductor element is used as some or all of the gas to be introduced into the reaction container of the said apparatus for manufacturing halogen gas through the gas introduction part provided with the said reaction container.

The present invention has simplicity in use and can maintain safety in handling source materials because it allows a series of processes to be performed in an air-tight reaction container and the generated fine particles can be treated in the form of a vapor phase all the time by removing them through capture or collection.

The present invention can manufacture halogen gas in the same facility where the halogen gas is used.

Furthermore, the present invention is a highly versatile technique which allows the halogen gas drawn from the apparatus for manufacturing halogen gas to be conveyed to the vacuum chamber which accommodates substrates to be processed in a semiconductor manufacturing process; the exhaust gas produced during the process in the vacuum chamber to be recovered; and those suitable as source material to be returned to the apparatus for manufacturing halogen gas and be circulated for reuse.

### BRIEF DESCRIPTION OF THE DRAWINGS

FIG. 1 is a cross sectional view showing an example of the apparatus for manufacturing halogen gas of the present invention.

FIG. 2 is a cross sectional view showing another example of the apparatus for manufacturing halogen gas of the present invention.

FIG. 3 is a schematic view of an example of the halogen gas recovery and circulatory system of the present invention.

### DETAILED DESCRIPTION OF THE INVENTION

Preferred embodiments of the present invention will be described as follows, based on the attached drawings

### First Embodiment

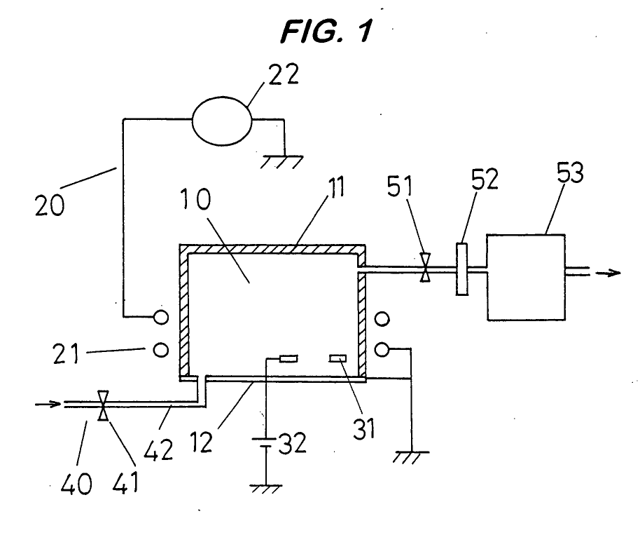

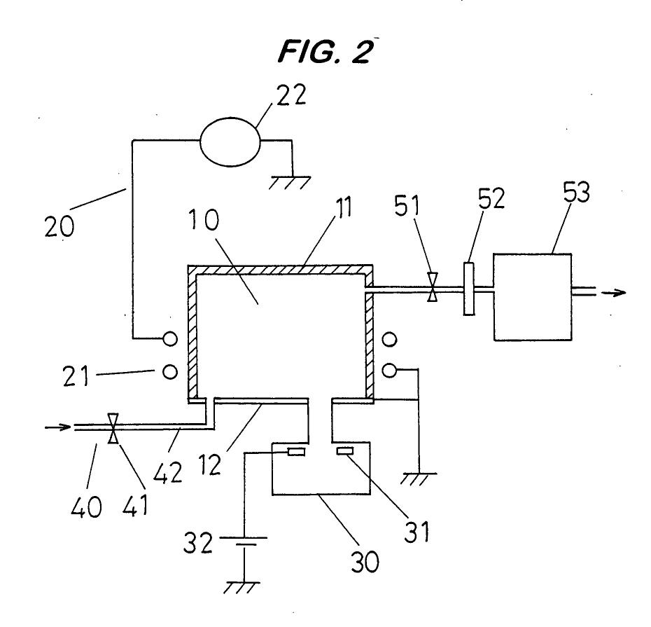

An example of the apparatus for manufacturing halogen gas of the present invention which manufactures halogen gas from a halogen element-containing gas will be described with reference to FIGS. 1 and 2.

The apparatus for manufacturing halogen gas of the present embodiment includes: a reaction container 10 in which a plasma chemical reaction is taken place; a plasma exciting electric field application part 20 which generates plasmas in the reaction container 10; a fine particle collecting part provided either in the reaction container 10 (FIG. 1) or in a fine particle collection container 30 (FIG. 2) connecting with the reaction container 10; and a gas introduction part 40 which leads gas into the reaction container 10.

In the present embodiment, as a process for generating plasmas, ICP (Inductive Coupled Plasma) is employed. Plasmas could be generated by other processes which are not illustrated.

The reaction container 10 is composed of a reaction container part 11 made from insulating material and a reaction container part 12 made from metallic material. In order to avoid corrosion due to the fluorine gas to be generated, aluminum oxide is used as the insulating material, and hastelloy or pure aluminum subjected to a surface passivation treatment is used as the metallic material.

In the reaction container 10, the reaction container part 12 made from the metallic material is grounded, which allows the formation of a preferable potential between the reaction container 10 and an ICP coil 21, thereby controlling plasma potential.

The plasma exciting electric field application part 20 is composed of the ICP coil 21 and a plasma exciting RF power supply 22. The plasmas are generated in the reaction container 10 by flowing a high frequency current into the ICP coil 21 from the plasma exciting RF power supply 22.

In the present embodiment, the fine particle collecting part is an electrode plate 31 applied with a positive potential against the ground. The electrode plate 31 is a doughnut-shaped metallic disk, and is installed in the reaction container 10 (shown in FIG. 1) or in the fine particle collection container 30 (shown in FIG. 2) connecting with the reaction container 10, so as to be connected to the DC power supply 32.

The gas introduction part 40 controlling the amount of gas to be introduced into the reaction container 10 includes a gas introduction pipe 42 and a gas introduction valve 41, which is attached in the pipe 42.

In the present embodiment, a halogen gas drawing part, which is composed of a gas drawing valve 51, a filter 52, and a pump 53, is provided to draw halogen gas from the reaction container 10. However, this is not the only approach to drawing halogen gas from the reaction container 10, and other approaches could be employed.

In the present embodiment, the reaction container 10 can be evacuated by the pump 53, with the gas introduction valve 41 closed and the gas drawing valve 51 open.

### Second Embodiment

A method for manufacturing fluorine gas by using the apparatus for manufacturing halogen gas shown in FIG. 1 will be described as follows by employing SiF₄ gas as the material expressed in the chemical formula AᵢXⱼ (A:Si, X:F, i=1, and j=4).

First, the reaction container 10 is evacuated by the pump 53, while the gas introduction valve 41 is closed and the gas drawing valve 51 is opened.

The gas drawing valve 51 is closed, then the pipe for introducing SiF₄ gas is connected with the gas introduction pipe 42, and 100 milliliters of SiF₄ gas is introduced into the reaction container 10 in such a manner that the pressure inside the reaction container 10 becomes 1.5 to 2.5 kPa.

After that, the gas introduction valve 41 is closed to seal SiF₄ gas into the reaction container 10. In this state, 13.56 MHz, 2 KW of power is applied from the plasma exciting RF power supply 22 to generate plasmas in the reaction container 10, and at the same time, 100 volts of positive potential is applied from the DC power supply 32 to the electrode plate 31 installed in the reaction container 10. This produces a plasma chemical reaction (for example, SiF₄ Si fine particles+F or F₂ (gas)), and the negatively charged Si fine particles are collected to the electrode plate 31 by the electric field formed between the electric plate 31 applied with a positive potential against the ground and the space where plasmas are generated. Thus, Si fine particles are removed from the reaction container 10 so as to proceed the plasma chemical reaction.

The plasma chemical reaction is completed in about 60 seconds, and then the application of 13.56 MHz of high frequency is suspended.

By opening the gas drawing valve 51 and running the pump 53, the fluorine gas generated in the reaction container 10 can be drawn out.

### Third Embodiment

The following is a description of a method for manufacturing fluorine gas by using the apparatus for manufacturing halogen gas shown in FIG. 2, while employing a mixture gas containing SiF₄ as the material expressed in the chemical formula AᵢXⱼ (A:Si, X:F, i=1, and j=4) and also containing oxygen gas to stimulate the reaction.

First, the gas introduction valve 41 is closed, the gas drawing valve 51 is opened, and the reaction container 10 is evacuated by the pump 53.

Then, the gas drawing valve 51 is closed, the container containing a mixture gas of SiF₄ gas and oxygen gas is connected with the gas introduction pipe 42, and 100 milliliters of the mixture gas is introduced into the reaction container 10 in such a manner that the pressure inside the reaction container 10 becomes 1.5 to 2.5 kPa.

After that, the gas introduction valve 41 is closed to seal the mixture gas into the reaction container 10. In this state, 13.56 MHz, 2 KW of power is applied from the plasma exciting RF power supply 22 to generate plasmas in the reaction container 10, and at the same time, 100 volts of positive potential is applied to the electrode plate 31 installed in the fine particle collection chamber 30 from the DC power supply 32. This produces a plasma chemical reaction (for example, SiF₄+O₂→fine particles composed of Si and SiO₂+F or F₂ (gas)), and the negatively charged fine particles composed of Si and SiO₂ are collected to the fine particle collection container 30 from the reaction container 10 by the electric field formed between the electrode plate 31 applied with a positive potential against the ground and the space where plasmas are generated. Thus, the fine particles composed of Si and SiO₂ are removed from the reaction container 10 so as to proceed the plasma chemical reaction.

The plasma chemical reaction is completed in only 20 seconds or so, and then the application of 13.56 MHz of high frequency is suspended.

By opening the gas drawing valve 51 and running the pump 53, the fluorine gas generated in the reaction container 10 can be drawn out.

In the before described method, oxygen gas could be replaced by nitrogen gas to obtain the same effects. In that case, the fine particles to be generated are a mixture of Si and SiN.

Also, in the before described method, oxygen element-containing AₖXₗOₘ gas or AᵣXₛNₜ gas can be used as the halogen element-containing gas to obtain the same effects.

### Fourth Embodiment

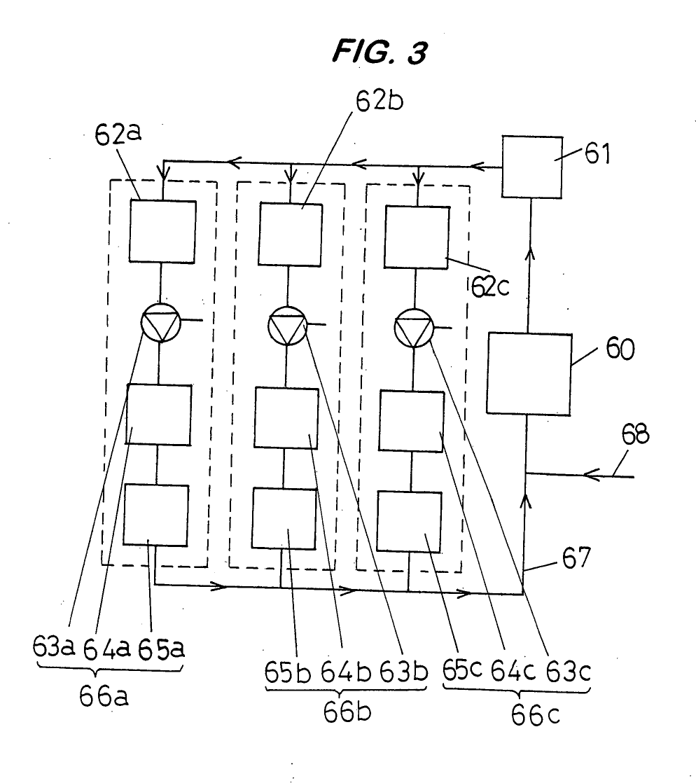

An example of the halogen gas recovery and circulatory system of the present invention and a method for recovering and circulating halogen gas using this system will be described as follows with reference to FIG. 3.

In the halogen gas recovery and circulatory system of the present embodiment, vacuum chambers 62a, 62b, 62c of the semiconductor manufacturing equipment are respectively connected with gas separation and refinement mechanisms 66a, 66b, and 66c. The gas separation and refinement mechanisms 66a, 66b and 66c recover exhaust gas produced during the process in the vacuum chambers 62a, 62b, 62c, and separate the gas containing halogen element and metallic element or semiconductor element from the exhaust gas to refine it. A pipe 67, which conveys the separated and refined gas containing halogen element and metallic element or semiconductor element from the gas separation and refinement mechanisms 66a, 66b, and 66c, is connected with the gas introduction pipe 68 of the halogen gas manufacturing apparatus 60. The halogen gas drawing part 61 connected with the halogen gas manufacturing apparatus 60 is connected with the halogen gas introduction parts of the vacuum chambers 62a, 62b, and 62c of the semiconductor manufacturing equipment.

As the halogen gas manufacturing apparatus 60, the apparatus shown in FIG. 1 or FIG. 2 described in the first embodiment is used. The halogen gas drawn from the halogen gas manufacturing apparatus 60 via the halogen gas drawing part 61 composed of the gas drawing valve, filter, and pump that are unillustrated is conveyed to the vacuum chambers 62a, 62b, and 62c which are processing equipments such as etching equipments used in the process of manufacturing semiconductors. As the vacuum chambers 62a, 62b, and 62c, process chambers (vacuum chambers) for dry-etching silicon dioxide (SiO₂), for example, can be used, and in this case the process produces gas such as CF₄, O₂, CO, CO₂, F₂, or SiF₄.

In the present embodiment, the gas separation and refinement mechanisms 66a, 66b, and 66 care composed of the vacuum pumps 63a, 63b, and 63c; the storage parts 64a, 64b, and 64c; and the gas separation and refinement parts 65a, 65b, and 65c, respectively. The gas separation and refinement mechanisms of the present embodiment are just one example, and their constitution is not the only one possible.

The exhaust gas produced during the process in the vacuum chambers 62a, 62b, and 62c is conveyed to the vacuum pumps 63a, 63b, and 63c via the pipe. As the vacuum pumps 63a, 63b, and 63c, dry pumps can be used, for example.

The vacuum pumps 63a, 63b, and 63c bring the degree of vacuum in the connected vacuum chambers 62a, 62b, and 62c to the predetermined reduced pressure conditions according to the process, and subject the exhaust gas produced during the process in the vacuum chambers 62a, 62b, and 62c to the atmospheric pressure.

In the present embodiment, the exhaust gas being subjected to the atmospheric pressure is conveyed to the storage parts 64a, 64b, and 64c, and trapped and stored in the form of liquid or solid using low temperatures. The storage parts 64a, 64b, and 64c do not have to be formed independently from the gas separation and refinement parts 65a, 65b, and 65c.

In the gas separation and refinement parts 65a, 65b, and 65c, differences in the chemical properties of the gases composing the exhaust gas, such as their boiling points are used so as to divide the exhaust gas into the gases containing halogen element and metallic element or semiconductor element. For example, the exhaust gas is divided into the gases expressed in the chemical formula AᵢXⱼ, AₖXₗOₘ, and AᵣXₛNₜ, and the other gases. If necessary, the gases are dried by using a dehumidifier (not illustrated). Furthermore, it is possible to provide a compressor in each of the gas separation and refinement parts 65a, 65b and 65c.

The principle of storing, separating, and refining the exhaust gas produced during the process in the vacuum chambers 62a, 62b, and 62c is not particularly restricted. It can be appropriately selected in accordance with the ratio of the components in the exhaust gas produced during the process in the vacuum chamber 62a and others.

The gas containing halogen element and metallic element or semiconductor element which has been separated and refined through the gas separation and refinement mechanisms 66a, 66b, and 66c passes through the pipe 67 and is conveyed to the gas introduction pipe 68 of the halogen gas manufacturing apparatus 60.

Therefore, it is possible that the halogen gas manufacturing apparatus 60 of the present invention is installed in the line of a semiconductor manufacturing process, and the halogen gas obtained by the halogen gas manufacturing apparatus 60 is conveyed into the vacuum chamber 62a and others of the semiconductor manufacturing equipment. After the exhaust gas containing halogen element and metallic element or semiconductor element produced during the process in the vacuum chamber 62a and others is recovered from the vacuum chamber 62a and others, those suitable as source material are returned to the halogen gas manufacturing apparatus 60 and circulated for reuse. Therefore, it becomes possible to reduce or get rid of the gas supply from the gas introduction part 67 of the halogen gas manufacturing apparatus 60.

The constitutions and requirements described in the attached drawings and the before described embodiments are simplified for a better understanding of the present invention. The present invention is not restricted to the before described embodiments, and its constitutions and requirements can be variously modified unless they do not depart from the scope of the technical principle shown in the claims.

1. A method for manufacturing halogen gas, comprising the steps of: introducing gas expressed in the chemical formula AᵢXⱼ (A represents metallic element or semiconductor element; X represents halogen element; and i and j represent integers) into a reaction container in vacuum; generating plasmas in the reaction container so as to produce a plasma chemical reaction; removing fine particles produced by the plasma chemical reaction and containing an element other than halogen element as the major constituent from the reaction container so as to generate halogen gas in the reaction container.

2. A method for manufacturing halogen gas, comprising the steps of: introducing gas expressed in the chemical formula AᵢXⱼ (A represents metallic element or semiconductor element; X represents halogen element; and i and j represent integers) into a reaction container in vacuum; generating plasmas in the reaction container so as to produce a plasma chemical reaction; collecting fine particles produced by the plasma chemical reaction and containing an element other than halogen element as the major constituent to a fine particle collecting part installed in the reaction container or in a fine particle collection container connecting with the reaction container so as to proceed the plasma chemical reaction, thereby generating halogen gas in the reaction container.

3. A method for manufacturing halogen gas, comprising the steps of: introducing gas expressed in the chemical formula AₖXₗOₘ (A represents metallic element or semiconductor element; X represents halogen element; O represents oxygen; and k, l, and m represent integers) into a reaction container in vacuum; generating plasmas in the reaction container so as to produce a plasma chemical reaction; collecting fine particles produced by the plasma chemical reaction and containing an element other than halogen element as the major constituent to a fine particle collecting part installed in the reaction container or in a fine particle collection container connecting with the reaction container so as to proceed the plasma chemical reaction, thereby generating halogen gas in the reaction container.

4. A method for manufacturing halogen gas, comprising the steps of: introducing gas expressed in the chemical formula AᵣXₛNₜ (A represents metallic element or semiconductor element; X represents halogen element; N represents nitrogen; and r, s, and t represent integers) into a reaction container in vacuum; generating plasmas in the reaction container so as to produce a plasma chemical reaction; collecting fine particles produced by the plasma chemical reaction and containing an element other than halogen element as the major constituent to a fine particle collecting part installed in the reaction container or in a fine particle collection container connecting with the reaction container so as to proceed the plasma chemical reaction, thereby generating halogen gas in the reaction container.

5. A method for manufacturing halogen gas according to claim 2, wherein the fine particle collecting part includes an electrode plate applied with a positive potential against the ground.

6. A method for manufacturing halogen gas according to claim 1, wherein A represents silicon (Si), X represents fluorine (F), and i<j.

7. A method for manufacturing halogen gas according to claim 1, wherein the gas introduced into a reaction container in vacuum further contains oxygen gas or nitrogen gas.

8-10. (canceled)
